(19) United States
(12) Patent Application Publication
(10) Pub. No.: US 2005/0281282 A1
(43) Pub. Date: Dec. 22, 2005

(54) Internal messaging within a switch

(76) Inventors: Henry J. Gonzalez, Belle Mead, NJ (US); Govindaswamy Nallur, Maple Shade, NJ (US); James C. Wright, Sewell, NJ (US)

Correspondence Address: BECK AND TYSVER P.L.L.C., 2900 THOMAS AVENUE SOUTH, SUITE 100, MINNEAPOLIS, MN, 55416, US

(21) Appl. No.: 10/873,372

(22) Filed: Jun. 21, 2004

(51) Int. Cl. H04L 12/66

(52) U.S. Cl. 370/422; 370/237; 370/238; 370/351

(57) ABSTRACT

A queuing mechanism is presented that allows port data and processor data to share the same crossbar data pathway without interference. An ingress memory subsystem is dividing into a plurality of virtual output queues according to the switch destination address of the data. Port data is assigned to the address of the physical destination port, while processor data is assigned to the address of one of the physical ports serviced by the processor. Different classes of service are maintained in the virtual output queues to distinguish between port data and processor data. This allows flow control to apply separately to these two classes of service, and also allows a traffic shaping algorithm to treat port data differently than processor data.

### RELATED APPLICATION

This application is related to U.S. Patent Application entitled “Fibre Channel Switch,” Ser. No. ______, attorney docket number 3194, filed on even date herewith with inventors in common with the present application. This related application is hereby incorporated by reference.

### FIELD OF THE INVENTION

The present invention relates to internal communications within a switch. More particularly, the present invention relates to sharing internal, processor directed communication over the same switch network as external data communications.

### BACKGROUND OF THE INVENTION

Fibre Channel is a switched communications protocol that allows concurrent communication among servers, workstations, storage devices, peripherals, and other computing devices. Fibre Channel can be considered a channel-network hybrid, containing enough network features to provide the needed connectivity, distance and protocol multiplexing, and enough channel features to retain simplicity, repeatable performance and reliable delivery. Fibre Channel is capable of full-duplex transmission of frames at rates extending from 1 Gbps (gigabits per second) to 10 Gbps. It is also able to transport commands and data according to existing protocols such as Internet protocol (IP), Small Computer System Interface (SCSI), High Performance Parallel Interface (HIPPI) and Intelligent Peripheral Interface (IPI) over both optical fiber and copper cable.

In a typical usage, Fibre Channel is used to connect one or more computers or workstations together with one or more storage devices. In the language of Fibre Channel, each of these devices is considered a node. One node can be connected directly to another, or can be interconnected such as by means of a Fibre Channel fabric. The fabric can be a single Fibre Channel switch, or a group of switches acting together. Technically, the N_port (node ports) on each node are connected to F_ports (fabric ports) on the switch. Multiple Fibre Channel switches can be combined into a single fabric. The switches connect to each other via E-Port (Expansion Port) forming an interswitch link, or ISL.

A Fibre Channel switch uses a routing table and the destination information found within the Fibre Channel frame header to route the Fibre Channel frames from one port to another. In most cases, the switch assigns each of its ports an internal address designation, also known as a switch destination address (or SDA). The primary task of routing a frame through a switch is assigning an SDA for each incoming frame. The frames are then sent over one or more crossbar switch elements, which establish connections between one port and another based upon the SDA assigned to a frame during routing.

In most cases, a Fibre Channel switch having more than a few ports utilizes a plurality of microprocessors to control the various elements of the switch. These microprocessors ensure that all of the components of the switch function appropriately. To operate cooperatively, it is necessary for the microprocessors to communicate with each other. It is also often necessary to communicate with the microprocessors from outside the switch.

In prior art switches, microprocessor messages are kept separate from the data traffic. This is because it is usually necessary to ensure that urgent internal messages are not delayed by data traffic congestion, and also to ensure that routine status messages do not unduly slow data traffic. Unfortunately, creating separate data and message paths within a large Fibre Channel switch can add a great deal of complexity and cost to the switch. What is needed is a technique that allows internal messages and real data to share the same data pathways within a switch without either type of communication unduly interfering with the other.

### SUMMARY OF THE INVENTION

The foregoing needs are met, to a great extent, by the present invention, wherein a queuing mechanism is used to allow port data and processor to share the same crossbar data pathways without unduly interfering with each other. An ingress memory subsystem is divided into a plurality of virtual output queues according to the switch destination address of the data. Port data is assigned to the switch destination address of its physical destination port, while processor data is assigned to the switch destination address of one of the physical ports serviced by the processor. Different classes of service are maintained in the virtual output queues to distinguish between port data and processor data. This allows flow control to apply separately to these two classes of service, and also allows a traffic-shaping algorithm to treat port data differently than processor data.

When the processor data is received from the crossbar, it is stored in an output class of service queue according to the data's switch destination address. A separate output class of service indicator divides the queues for each switch destination address. All processor data is preferably assigned to a selected port serviced by a processor, and to a designated output class of service indicator.

An outbound processing module handles data addressed to the selected port serviced by the processor. This outbound processing module examines all data received from the output class of service queue for its port. If the data is assigned to the output class of service indicator designated as microprocessor traffic, the outbound processing module stores this data in a separate microprocessor buffer. An interrupt is provided to the microprocessor interface, and the microprocessor then receives the data from the microprocessor buffer. All data received by the outbound processing module that is assigned to the designated outbound class of service indicator(s) is submitted to the port for transmission out of the switch.

### BRIEF DESCRIPTION OF THE DRAWINGS

FIG. 1 is a block diagram of one possible Fibre Channel switch in which the present invention can be utilized.

FIG. 2 is a block diagram showing the details of the port protocol device of the Fibre Channel switch shown in FIG. 2.

FIG. 3 is a block diagram showing the interrelationships between the duplicated elements on the port protocol device of FIG. 2.

FIG. 4 is a block diagram showing the queuing utilized in an upstream switch and a downstream switch communicating over an interswitch link.

FIG. 5 is a block diagram showing additional details of the virtual output queues of FIG. 4.

### DETAILED DESCRIPTION OF THE INVENTION

1. Switch 100

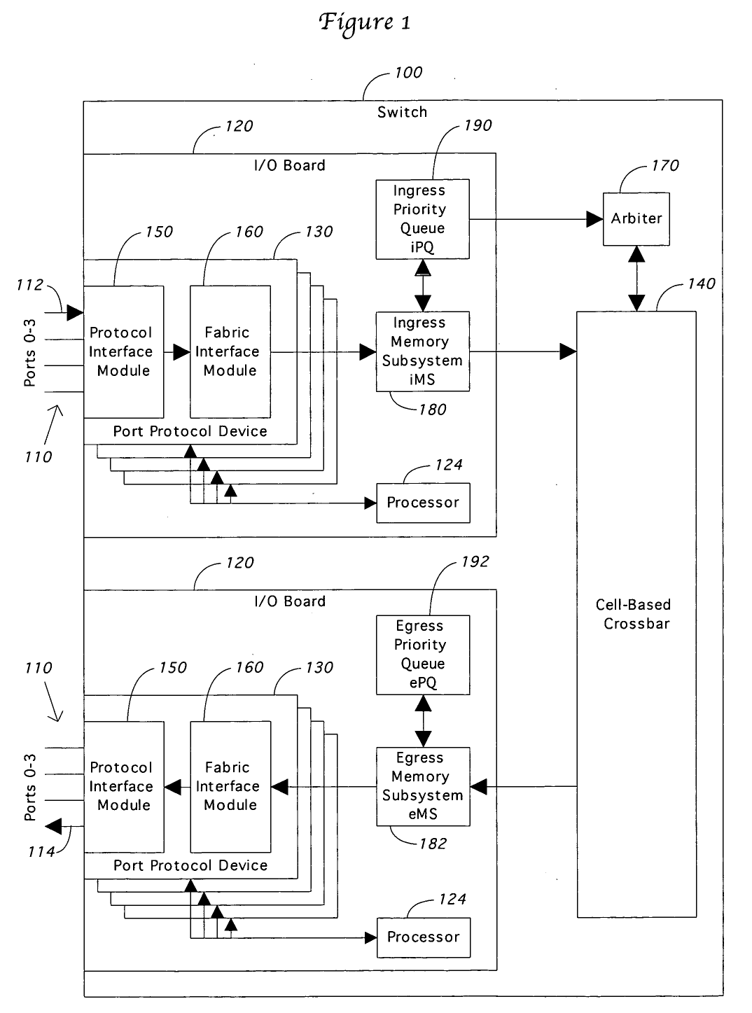

The present invention is best understood after examining the major components of a Fibre Channel switch, such as switch 100 shown in FIG. 1. The components shown in FIG. 1 are helpful in understanding the applicant's preferred embodiment, but persons of ordinary skill will understand that the present invention can be incorporated in switches of different construction, configuration, or port counts.

Switch 100 is a director class Fibre Channel switch having a plurality of Fibre Channel ports 110. The ports 110 are physically located on one or more I/O boards 120 inside of switch 100. Although FIG. 1 shows only two I/O boards 120, a director class switch 100 would contain eight or more such boards 120. The preferred embodiment described in this application can contain thirty-two such I/O boards 120. Each board 120 contains a microprocessor 124 that, along with its RAM and flash memory (not shown), is responsible for controlling and monitoring the other components on the boards 120 and for messaging between the boards 120.

In the preferred embodiment, each board 120 also contains four port protocol devices (or PPDs) 130. These PPDs 130 can take a variety of known forms, including an ASIC, an FPGA, a daughter card, or even a plurality of chips found directly on the boards 120. In the preferred embodiment, the PPDs 130 are ASICs, and can be referred to as the FCP ASICs, since they are primarily designed to handle Fibre Channel protocol data. Each PPD 130 manages and controls four ports 110. This means that each I/O board 120 in the preferred embodiment contains sixteen Fibre Channel ports 110.

The I/O boards 120 are connected to one or more crossbars 140 designed to establish a switched communication path between two ports 110. Although only a single crossbar 140 is shown, the preferred embodiment uses four or more crossbar devices 140 working together. In the preferred embodiment, crossbar 140 is cell-based, meaning that it is designed to switch small, fixed-size cells of data. This is true even though the overall switch 100 is designed to switch variable length Fibre Channel frames.

The Fibre Channel frames are received on a port 110, such as input port 112, and are processed by the port protocol device 130 connected to that port 112. The PPD 130 contains two major logical sections, namely a protocol interface module 150 and a fabric interface module 160. The protocol interface module 150 receives Fibre Channel frames from the ports 110 and stores them in temporary buffer memory. The protocol interface module 150 also examines the frame header for its destination ID and determines the appropriate output or egress port 114 for that frame. The frames are then submitted to the fabric interface module 160, which segments the variable-length Fibre Channel frames into fixed-length cells acceptable to crossbar 140.

The fabric interface module 160 then transmits the cells to an ingress memory subsystem (iMS) 180. A single iMS 180 handles all frames received on the I/O board 120, regardless of the port 110 or PPD 130 on which the frame was received. When the ingress memory subsystem 180 receives the cells that make up a particular Fibre Channel frame, it treats that collection of cells as a variable length packet. The iMS 180 assigns this packet a packet ID (or “PID”) that indicates the cell buffer address in the iMS 180 where the packet is stored. The PID and the packet length is then passed on to the ingress Priority Queue (iPQ) 190, which organizes the packets in iMS 180 into one or more queues, and submits those packets to crossbar 140. Before submitting a packet to crossbar 140, the iPQ 190 submits a “bid” to arbiter 170. When the arbiter 170 receives the bid, it configures the appropriate connection through crossbar 140, and then grants access to that connection to the iPQ 190. The packet length is used to ensure that the connection is maintained until the entire packet has been transmitted through the crossbar 140, although the connection can be terminated early.

A single arbiter 170 can manage four different crossbars 140. The arbiter 170 handles multiple simultaneous bids from all iPQs 190 in the switch 100, and can grant multiple simultaneous connections through crossbars 140. The arbiter 170 also handles conflicting bids, ensuring that no output port 114 receives data from more than one input port 112 at a time.

The output or egress memory subsystem (eMS) 182 receives the data cells comprising the packet from the crossbar 140, and passes a packet ID to an egress priority queue (ePQ) 192. The egress priority queue 192 provides scheduling, traffic management, and queuing for communication between egress memory subsystem 182 and the PPD 130 in egress I/O board 120. When directed to do so by the ePQ 192, the eMS 182 transmits the cells comprising the Fibre Channel frame to the egress portion of PPD 130. The fabric interface module 160 then reassembles the data cells and presents the resulting Fibre Channel frame to the protocol interface module 150. The protocol interface module 150 stores the frame in its buffer, and then outputs the frame through output port 114.

In FIG. 1, the I/O board 120 connected to the input port 112 is shown without with an egress memory subsystem 182 and an egress priority queue 192, while the I/O board 120 connected to the egress port 114 is shown without an ingress memory subsystem 180 and an ingress priority queue 190. This was done to illustrate data flow within the switch 100. All I/O boards 120 in the preferred embodiment switch 100 have both ingress and egress memory subsystems 180, 182 and priority queues 190, 192.

In the preferred embodiment, crossbar 140 and the related memory components 180, 182, 190, 192 are part of a commercially available cell-based switch fabric, such as the nPX8005 or “Cyclone” switch fabric manufactured by Applied Micro Circuits Corporation of San Diego, Calif. More particularly, in the preferred embodiment, the crossbar 140 is the AMCC S8705 Crossbar product, the arbiter 170 is the AMCC S8605 Arbiter, the iPQ 190 and ePQ 192 are AMCC S8505 Priority Queues, and the iMS 180 and eMS 182 are AMCC S8905 Memory Subsystems, all manufactured by Applied Micro Circuits Corporation.

2. Port Protocol Device 130

a) Link Controller Module 300

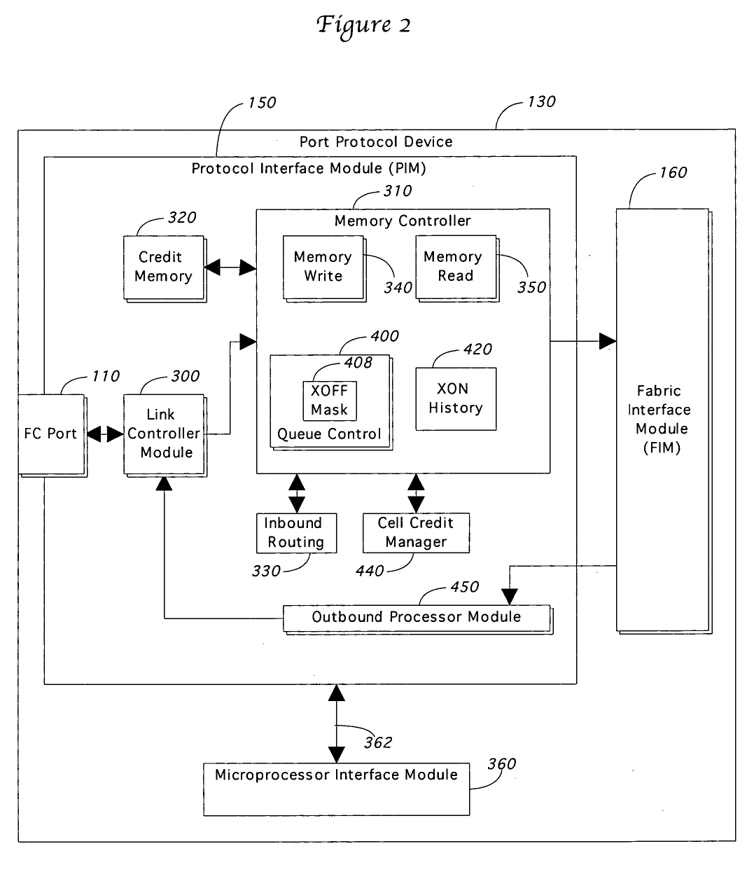

FIG. 2 shows the components of one of the four port protocol devices 130 found on each of the I/O boards 120. As explained above, incoming Fibre Channel frames are received over a port 110 by the protocol interface 150. A link controller module (LCM) 300 in the protocol interface 150 receives the Fibre Channel frames and submits them to the memory controller module 310.

One of the primary jobs of the link controller module 300 is to compress the start of frame (SOF) and end of frame (EOF) codes found in each Fibre Channel frame. By compressing these codes, space is created for status and routing information that must be transmitted along with the data within the switch 100. More specifically, as each frame passes through PPD 130, the PPD 130 generates information about the frame's port speed, its priority value, the internal switch destination address (or SDA) for the source port 112 and the destination port 114, and various error indicators. This information is added to the SOF and EOF in the space made by the LCM 300. This “extended header” stays with the frame as it traverses through the switch 100, and is replaced with the original SOF and EOF as the frame leaves the switch 100. The LCM 300 uses a SERDES chip (such as the Gigablaze SERDES available from LSI Logic Corporation, Milpitas, Calif.) to convert between the serial data used by the port 110 and the 10-bit parallel data used in the rest of the protocol interface 150. The LCM 300 performs all low-level link-related functions, including clock conversion, idle detection and removal, and link synchronization. The LCM 300 also performs arbitrated loop functions, checks frame CRC and length, and counts errors.

b) Memory Controller Module 310

The memory controller module 310 is responsible for storing the incoming data frame on the inbound frame buffer memory 320. Each port 110 on the PPD 130 is allocated a separate portion of the buffer 320. Alternatively, each port 110 could be given a separate physical buffer 320. This buffer 320 is also known as the credit memory, since the BB_Credit flow control between switch 100 and the upstream device is based upon the size or credits of this memory 320. The memory controller 310 identifies new Fibre Channel frames arriving in credit memory 320, and shares the frame's destination ID and its location in credit memory 320 with the inbound routing module 330.

The routing module 330 of the present invention examines the destination ID found in the frame header of the frames and determines the switch destination address (SDA) in switch 100 for the appropriate destination port 114. The router 330 is also capable of routing frames to the SDA associated with one of the microprocessors 124 in switch 100. In the preferred embodiment, the SDA is a ten-bit address that uniquely identifies every port 110 and processor 124 in switch 100. A single routing module 330 handles all of the routing for the PPD 130. The routing module 330 then provides the routing information to the memory controller 310.

The memory controller 310 consists of four primary components, namely a memory write module 340, a memory read module 350, a queue control module 400, and an XON history register 420. A separate write module 340, read module 350, and queue control module 400 exist for each of the four ports 110 on the PPD 130. A single XON history register 420 serves all four ports 110. The memory write module 340 handles all aspects of writing data to the credit memory 320. The memory read module 350 is responsible for reading the data frames out of memory 320 and providing the frame to the fabric interface module 160.

c) Queue Control Module 400

The queue control module 400 stores the routing results received from the inbound routing module 330. When the credit memory 320 contains multiple frames, the queue control module 400 decides which frame should leave the memory 320 next. In doing so, the queue module 400 utilizes procedures that avoid head-of-line blocking.

The queue control module 400 maintains two separate queues for the credit memory 320, namely a deferred queue and backup queue. The deferred queue stores the frame headers and locations in buffer memory 320 for frames waiting to be sent to a destination port 114 that is currently busy. The backup queue stores the frame headers and buffer locations for frames that arrive at the port 110 while the deferred queue is sending deferred frames to their destination. The queue control module 400 also contains header select logic that determines the state of the queue control module 400. This determination is used to select the next frame to be submitted to the FIM 160. For instance, the next frame might be the most recently received frame from the link controller module 300, or it may be a frame stored in either the deferred queue or the backup queue. The header select logic then supplies to the memory read module 350 a valid buffer address containing the next frame to be sent. The functioning of the backup queue, the deferred queue, and the header select logic are described in more detail in the incorporated “Fibre Channel Switch” patent application.

The queue control module 400 uses an XOFF mask 408 to determine the current congestion state of every destination in the switch 100. This determination is necessary to determine whether a frame should be sent to its destination, or be stored in the deferred queue for later processing. The XOFF mask 408 contains a congestion status bit for each port 110 within the switch 100. In one embodiment of the switch 100, there are five hundred and twelve physical ports 110 and thirty-two microprocessors 124 that can serve as a destination for a frame. Hence, the XOFF mask 408 uses a 544 by 1 look up table to store the “XOFF” status of each destination. If a bit in XOFF mask 408 is set, the port 110 corresponding to that bit is busy and cannot receive any frames. In the preferred embodiment, the XOFF mask 408 returns a status for a destination by first receiving the SDA for that port 110 or microprocessor 124. The look up table is examined for that SDA, and if the corresponding bit is set, the XOFF mask 408 asserts a “defer” signal which indicates to the rest of the queue control module 400 that the selected port 110 or processor 124 is busy.

The XON history register 420 is used to record the history of the XON status of all destinations in the switch. Under the procedure established for deferred queuing, the XOFF mask 408 cannot be updated with an XON event when the queue control 400 is servicing deferred frames in the deferred queue. During that time, whenever a port 110 changes status from XOFF to XON, the cell credit manager 440 updates the XON history register 420 rather than the XOFF mask 408. When a reset signal is activated, the entire content of the XON history register 420 is transferred to the XOFF mask 408. Registers within the XON history register 420 containing a zero will cause corresponding registers within the XOFF mask 408 to be reset. The dual register setup allows for XOFFs to be written at any time the cell credit manager 440 requires traffic to be halted, and causes XONs to be applied only when the header select logic allows for changes in the XON values.

The cell credit manager 440 is responsible for determining the status of each port 110 in the switch 100. If the cell credit manager 440 determines that a port 110 is busy, it sends an XOFF signal to the XOFF mask 408 and the XON history register 420. The cell credit manager 440 makes the determination of port status by tracking the flow of cells into the iMS 180 through a cell credit counting mechanism. For every local destination address in the switch 100, the credit module 440 makes a count of every cell that enters and exits the iMS 180. If cells for a certain port 110 are not exiting the iMS 180, the count in the credit module 440 will exceed a preset threshold. The credit module will then send out an XOFF signal for that port.

The present invention also recognizes flow control signals directly from the ingress memory subsystem 180 that request that all data stop flowing to that subsystem 180. When these signals are received, a “gross_xoff” signal is sent to the XOFF mask 408. The XOFF mask 408 is then able to combine the results of this signal with the status of every destination port 110 as maintained in its lookup table. When another portion of the switch 100 wishes to determine the status of a particular port 110, the internal switch destination address is submitted to the XOFF mask 408. This address is used to reference the status of that destination in the lookup table, and the result is ORed with the value of the gross_xoff signal. The resulting signal indicates the status of the indicated destination port.

d) Fabric Interface Module 160

When a Fibre Channel frame is ready to be submitted to iMS 180, the queue control 400 passes the selected frame's header and pointer to the memory read module 350. This read module 350 then takes the frame from the credit memory 320 and provides it to the fabric interface module 160. The fabric interface module 160 converts the variable-length Fibre Channel frames received from the protocol interface 150 into fixed-sized data cells acceptable to the cell-based crossbar 140. Each cell is constructed with a specially configured cell header appropriate to the cell-based switch fabric. In the preferred embodiment, the cell header includes a starting sync character, the switch destination address of the egress port 114 and a priority assignment from the inbound routing module 330, a flow control field and ready bit, an ingress class of service assignment, a packet length field, and a start-of-packet and end-of-packet identifier.

When necessary, the preferred embodiment of the fabric interface 160 creates fill data to compensate for the speed difference between the memory controller 310 output data rate and the ingress data rate of the cell-based crossbar 140. This process is described in more detail in the incorporated “Fibre Channel Switch” patent application.

Egress data cells are received from the crossbar 140 and stored in the egress memory subsystem 182. When these cells leave the eMS 182, they enter the egress portion of the fabric interface module 160. The FIM 160 then examines the cell headers, removes fill data, and concatenates the cell payloads to re-construct Fibre Channel frames with extended SOF/EOF codes. If necessary, the FIM 160 uses a small buffer to smooth gaps within frames caused by cell header and fill data removal. The egress portion of the FIM 160 also analyzes the ready bits of the cells received from the eMS 182. These ready bits allow the iMS 180 to manage flow control with the ingress portion of the FIM 160.

In the preferred embodiment, there are multiple links between each PPD 130 and the ingress/egress memory subsystems 180, 182. Each separate link uses a separate FIM 160. Preferably, each port 110 on the PPD 130 is given at least one separate link to the memory subsystems 180, 182, and therefore each port 110 is assigned one or more separate FIMs 160.

e) Outbound Processor Module 450

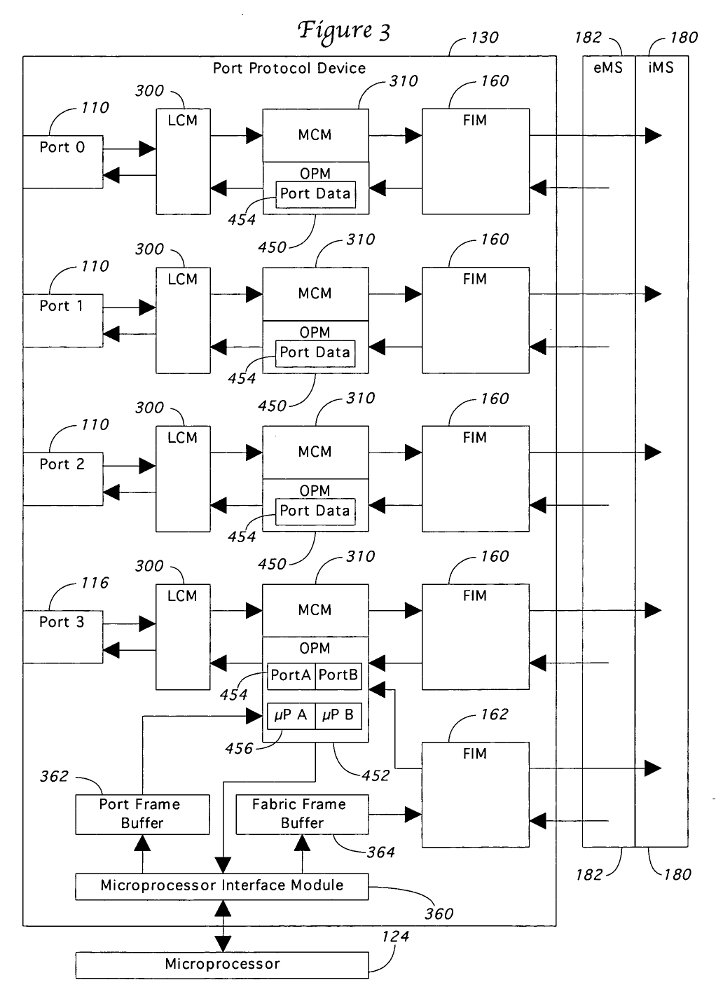

The FIM 160 submits frames received from the egress memory subsystem 182 to the outbound processor module (OPM) 450. As seen in FIG. 3, a separate OPM 450 is used for each port 110 on the PPD 130. The outbound processor module 450 checks each frame's CRC, and uses a port data buffer 454 to account for the different data transfer rates between the fabric interface 160 and the ports 110. The port data buffer 454 also helps to handle situations where the microprocessor 124 is communicating directly through one of the ports 110. When this occurs, the microprocessor-originating data has priority, the port data buffer 454 stores data arriving from the FIM 160 and holds it until the microprocessor-originated data frame is sent through the port 110. If the port data buffer 454 ever becomes too full, the OPM 450 is able to signal the eMS 182 to stop sending data to the port 110 using an XOFF flow control signal. An XON signal can later be used to restart the flow of data to the port 110 once the buffer 454 is less full.

The primary job of the outbound processor modules 450 is to handle data frames received from the cell-based crossbar 140 and the eMS 182 that are destined for one of the Fibre Channel ports 110. This data is submitted to the link controller module 300, which replaces the extended SOF/EOF codes with standard Fibre Channel SOF/EOF characters, performs 8b/10b encoding, and sends data frames through its SERDES to the Fibre Channel port 110.

Each port protocol device 130 has numerous ingress links to the iMS 180 and an equal number of egress links from the eMS 182. Each pair of links uses a different fabric interface module 160. Each port 110 is provided with its own outbound processor module 450. In the preferred embodiment, an I/O board 120 has a total of four port protocol devices 130, and a total of seventeen link pairs to the ingress and egress memory subsystems 180, 182. The first three PPDs 130 have four link pairs each, one pair for every port 110 on the PPD 130. The last PPD 130 still has four ports 110, but this PPD 130 has five link pairs to the memory subsystems 180, 182, as shown in FIG. 3. The fifth link pair is associated with a fifth FIM 162, and is connected to the OPM 452 handling outgoing communication for the highest numbered port 116 (i.e., the third port) on this last PPD 130. This last OPM 452 on the last PPD 130 on a I/O board 120 is special in that it has two separate FIM interfaces. The purpose of this special, dual port OPM 452 is to receive data frames from the cell-based switch fabric that are directed to the microprocessor 124 for that I/O board 120. This is described in more detail below.

In an alternative embodiment, the ports 110 might require additional bandwidth to the iMS 180, such as where the ports 110 can communicates at four gigabits per second and each link to the memory subsystems 180, 182 communicate at only 2.5 Gbps. In these embodiments, multiple links can be made between each port 110 and the iMS 180, each communication path having a separate FIM 160. In these embodiments, all OPMs 450 will communicate with multiple FIMs 160, and will have at least one port data buffer 454 for each FIM 160 connection.

3. Queues

a) Class of Service Queue 280

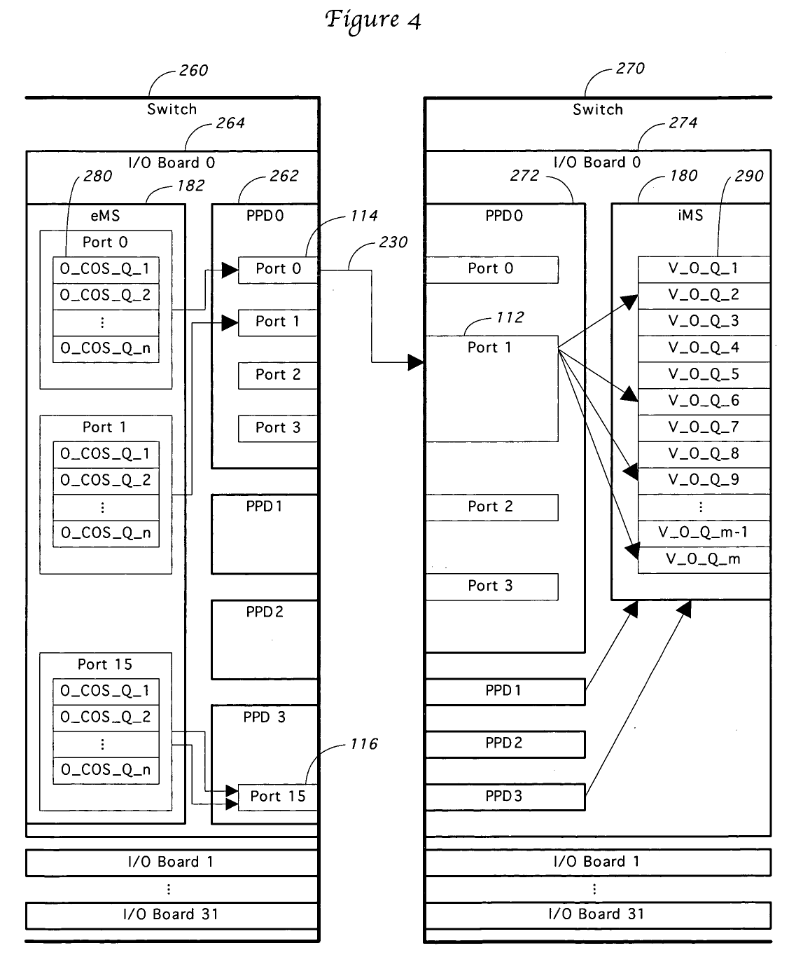

FIG. 4 shows two switches 260, 270 that are communicating over an interswitch link 230. The ISL 230 connects an egress port 114 on upstream switch 260 with an ingress port 112 on downstream switch 270. This egress port 114 is located on the first PPD 262 (labeled PPD 0) on the first I/O board 264 (labeled I/O board 0) on switch 260. This I/O board 264 contains a total of four PPDs 130, each containing four ports 110. This means I/O board 264 has a total of sixteen ports 110, numbered 0 through 15. In FIG. 4, switch 260 contains thirty-one other I/O boards 120, meaning the switch 260 has a total of five hundred and twelve ports 110. This particular configuration of I/O boards 120, PPDs 130, and ports 110 is for exemplary purposes only, and other configurations would clearly be within the scope of the present invention.

I/O board 264 has a single egress memory subsystem 182 to hold all of the data received from the crossbar 140 (not shown) for its sixteen ports 110. The data in eMS 182 is controlled by the egress priority queue 192 (also not shown). In the preferred embodiment, the ePQ 192 maintains the data in the eMS 182 in a plurality of output class of service queues (O_COS_Q) 280. Data for each port 110 on the egress I/O board 264 is kept in a total of “n” output class of service queues 280, with the number n reflecting the number of virtual channels 240 defined to exist with the ISL 230. When cells are received from the crossbar 140, the eMS 182 and ePQ 192 add the cell to the appropriate O_COS_Q 280 based on the destination SDA and priority value assigned to the cell. This information was determined by the inbound routing module 330 and placed in the cell header as the cell was created by the ingress FIM 160.

The output class of service queues 280 for a particular egress port 114 can be serviced according to any of a great variety of traffic shaping algorithms. For instance, the queues 280 can be handled in a round robin fashion, with each queue 280 given an equal weight. Alternatively, the weight of each queue 280 in the round robin algorithm can be skewed if a certain flow is to be given priority over another. It is even possible to give one or more queues 280 absolute priority over the other queues 280 servicing a port 110. The cells are then removed from the O_COS_Q 280 and are submitted to the PPD 262 for the egress port 114, which converts the cells back into a Fibre Channel frame and sends it across the ISL 230 to the downstream switch 270.

b) Virtual Output Queue 290

The frame enters downstream switch 270 over the ISL 230 through ingress port 112. This ingress port 112 is actually the second port (labeled port 1) found on the first PPD 272 (labeled PPD 0) on the first I/O board 274 (labeled I/O board 0) on switch 270. Like the I/O board 264 on switch 260, this I/O board 274 contains a total of four PPDs 130, with each PPD 130 containing four ports 110. With a total of thirty-two I/O boards 120, switch 270 has the same five hundred and twelve ports as switch 260.

When the frame is received at port 112, it is placed in credit memory 320. The D_ID of the frame is examined, and the frame is queued and a routing determination is made as described above. Assuming that the destination port on switch 270 is not XOFFed according to the XOFF mask 408 servicing input port 112, the frame will be subdivided into cells and forwarded to the ingress memory subsystem 180.

The iMS 180 is organized and controlled by the ingress priority queue 190, which is responsible for ensuring in-order delivery of data cells and packets. To accomplish this, the iPQ 190 organizes the data in its iMS 180 into a number (“m”) of different virtual output queues (V_O_Qs) 290. To avoid head-of-line blocking, a separate V_O_Q 290 is established for every destination within the switch 270. In switch 270, this means that there are at least five hundred forty-four V_O_Qs 290 (five hundred twelve physical ports 110 and thirty-two microprocessors 124) in iMS 180. The iMS 180 places incoming data on the appropriate V-O-Q 290 according to the switch destination address assigned to that data.

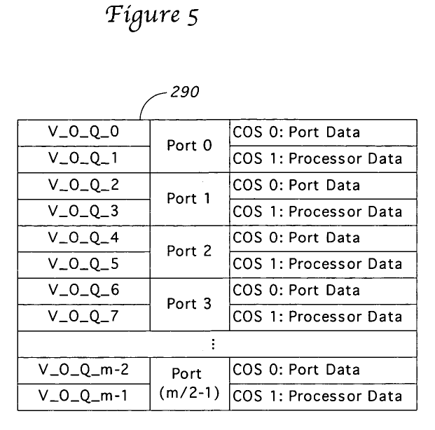

When using the AMCC Cyclone chipset, the iPQ 190 can configure up to 1024 V_O_Qs 290. In the preferred embodiment of the virtual output queue structure in iMS 180, all 1024 available queues 290 are used in a five hundred twelve port switch 270, with two V_O_Qs 290 being assigned to each port 110. This arrangement is shown in FIG. 5. One of these V_O_Qs 290 is dedicated to carrying real data destined to be transmitted out the designated port 110. The other V_O_Q 290 for that port 110 is dedicated to carrying traffic destined for the microprocessor 124 servicing that port 110. In this environment, the V_O_Qs 290 that are assigned to each port 110 can be considered two different class of service queues for that port 110, with one class of service for real data headed for a physical port 110, and another class of service for communications to one of the microprocessors 124. FIG. 5 shows the V_O_Qs 290 being assigned successively, with two consecutive queue numbers being assigned to the first port, and then to the second port 110, and so on. In this way, the class of service for each port can be considered appended to the SDA for the port at the least significant bit position, thereby creating the V_O_Q number. Alternative ways of merging the class of service indicator into the SDA for the port 110 are also possible, such as by providing eight consecutive identifiers per PPD 130 (as opposed to four-one per port 110), and assigning the class of service indicator as the fourth bit position before the last three SDA bit positions.

The FIM 160 is responsible for assigning data frames to either the real data class of service or to the microprocessor communication class of service. This is accomplished by placing an indication as to which class of service should be provided to an individual cell in a field found in the cell header. Since there are only two classes of service, this can be accomplished in a single bit, which can be placed adjacent to the switch destination address of the destination in the cell header. In this way, the present invention is able to separate internal messages and other microprocessor based communication from real data traffic. This is done without requiring a separate data network or using additional crossbars 140 dedicated to internal messaging traffic. And since the two V_O_Qs 290 for each port are maintained separately, real data traffic congestion on a port 110 does not affect the ability to send messages to the port, and vice versa.

Data in the V_O_Qs 290 is handled like the data in O_COS_Qs 280, such as by using round robin servicing. This means that different service levels can be provided to different virtual output queues 290. For instance, real data might be given twice as much bandwidth over the crossbar 140 as communications to a microprocessor 124, or vice versa.

4. Fabric to Microprocessor Communication

Communication directed to a microprocessor 124 can be sent over the crossbar 140 via the virtual output queues 290 of the iMS 180. This communication will be directed to one of the ports 110 serviced by the microprocessor 124, and will be assigned to the microprocessor class of service by the fabric interface module 160. In the preferred embodiment, each microprocessor 124 services numerous ports 110 on its I/O board 120. Hence, it is possible to design a switch 100 where communication to the microprocessor 124 could be directed to the switch destination address of any of its ports 110, and the communication would still be received by the microprocessor 124 as long as the microprocessor class of service was also specified. In the preferred embodiment, the switch 100 is simplified by specifying that all communication to a microprocessor 124 should go to the last port 110 on the board 120. More particularly, the preferred embodiment sends these communications to the third port 110 (numbered 0-3) on the third PPD 130 (numbered 0-3) on each board 120. Thus, to send communications to a microprocessor 124, the third port on the third PPD 130 is specified as the switch destination address, and the communication is assigned to the microprocessor class of service level on the virtual output queues 290.

The data is then sent over the crossbar 140 using the traffic shaping algorithm of the iMS 180, and is received at the destination side by the eMS 182. The eMS 182 will examine the SDA of the received data, and place the data in the output class of service queue structures 280 relating to the last port 110 on the last PPD 130 on the board 120. In FIG. 3, this was labeled port 116. In FIG. 4, this is “Port 15,” identified again by reference numeral 116. In one of the preferred embodiments, the eMS 182 uses eight classes of services for each port 110 (numbered 0-7) in its output class of service queues 280. In order for the output priority queue 280 to differentiate between real data directed to physical ports 110 and communication directed to microprocessors 124, microprocessor communication is again assigned to a specific class of service level. In the output class of service queues 280 in one embodiment, microprocessor communication is always directed to output class of service 7 (assuming eight classes numbered 0-7), on the last port 116 of an I/O board 120. All of these assignments are recorded in the cell headers of all microprocessor-directed cells entering the cell-based switch fabric and in the extended headers of the frames themselves. Thus, the SDA, the class of service for the virtual output queue 290, and the class of service for the output class of service queue 280 are all assigned before the cells enter the switch, either by the PPD 130 or the microprocessor 124 that submitted the data to the switch fabric. The assignment of a packet to output class of service seven on the last port 116 of an I/O board 120 ensures that this is a microprocessor-bound packet. Consequently, an explicit assignment to the microprocessor class of service in V_O_Q 290 by the routing module 330 is redundant and could be avoided in alternative switch designs.

As shown in FIG. 3, data to this port 116 utilizes a special, dual port OPM 452 connected to two separate fabric interface modules 160, each handling a separate physical connection to the eMS 182. The eMS 182 in the preferred embodiment views these two connections as two equivalent, available paths to the same location, and will use either path to communicate with this port 116. The OPM 452 therefore must therefore expect incoming Fibre Channel frames on both of its two FIMs 160, 162, and must be capable of handling frames directed either to the port 116 or the microprocessor 124. Thus, while other OPMs 454 have a single port data buffer 454 to handle communications received from the FIM 160, the dual port OPM 452 has two port data buffers 454 (one for each originating FIM 160, 162) and two microprocessor buffers 456 (one for each FIM 160, 162). To keep data frames in order, the dual port OPM 452 utilizes two one-bit FIFOs called “order FIFOs,” one for fabric-to-port frames and one for fabric-to-microprocessor frames. Depending on whether the frame comes from the first FIM 160 or the second FIM 162, the frame order FIFO is written with a ‘0’ or ‘1’ and the write pointer is advanced. The output of these FIFOs are available to the microprocessor interface 360 as part of the status of the OPM 452, and are also used internally by the OPM 452 to maintain frame order.

When the OPM 452 detects frames received from one of its two fabric interface modules 160, 162 that are labeled class of service level seven, the OPM 452 knows that the frames are to be delivered to the microprocessor 124. The frames are placed in one of the microprocessor buffers 456, and an interrupt is provided to the microprocessor interface module 360. The microprocessor 124 will receive this interrupt, and access the microprocessor buffers 456 to retrieve this frame. In so doing, the microprocessor 124 will read a frame length register in the buffer 456 in order to determine the length of frame found in the buffer. The microprocessor will also utilize the frame order FIFO to select the buffer 456 containing the next frame for the microprocessor 124. When the frame has been sent, the microprocessor 124 receives another interrupt.

5. Microprocessor to Fabric or Port Communication

Each port protocol device contains a microprocessor-to-port frame buffer 362 and a microprocessor-to-fabric frame buffer 364. These buffers 362, 364 are used by the microprocessor 124 to send frames to one of the local Fibre Channel ports 110 or to a remote destination through the switch fabric. Both of these frame buffers 362, 364 are implemented in the preferred embodiment as a FIFO that can hold one maximum sized frame or several small frames. Each frame buffer 362, 364 also has a control register and a status register associated with it. The control register contains a frame length field and destination bits, the latter of which are used solely by the port frame buffer 362. There are no hardware timeouts associated with these frame buffers 362, 364. Instead, microprocessor 124 keeps track of the frame timeout periods.

When one of the frame buffers 362, 364 goes empty, an interrupt is sent to the microprocessor 124. The processor 124 keeps track of the free space in the frame buffers 362, 364 by subtracting the length of the frames it transmits to these buffers 362, 364. This allows the processor 124 to avoid having to poll the frame buffers 362, 364 to see if there is enough space for the next frame. The processor 124 assumes that sent frames always sit in the buffer. This means that even when a frame leaves the buffer, firmware is not made aware of the freed space. Instead, firmware will set its free length count to the maximum when the buffer empty interrupt occurs. Of course, other techniques for managing the microprocessor 124 to buffer 362, 364 interfaces are well known and could also be implemented. Such techniques include credit-based or XON/XOFF flow control methods.

As mentioned above, in situations where the transmission speed coming over the port 110 is less than the transmission speed of a single physical link to the iMS 180, each of the first fifteen ports 110 uses only a single FIM 160. In these cases, although the last port 116 on an I/O board will receive data from the eMS 182 over two FIMs 160, 162, it will transmit data from the memory controller module 310 over a single FIM 160. This means that the microprocessor-to-fabric frame buffer 364 can use the additional capacity provided by the second FIM 162 as a dedicated link to the iMS 180 for microprocessor-originating traffic. This prevents a frame from ever getting stuck in the fabric frame buffer 364. However, in situations where each port 110 uses two FIMs 160 to meet the bandwidth requirement of port traffic, the fabric frame buffer 364 is forced to share the bandwidth provided by the second FIM 162 with port-originating traffic. In this case, frame data will occasionally be delayed in the fabric frame buffer 364.

Frames destined for a local port 110 are sent to the microprocessor-to-port frame buffer 362. The microprocessor 124 then programs the destination bits in the control register for the buffer 362. These bits determine which port or ports 110 in the port protocol device 130 should transmit the frame residing in the port frame buffer 362, with each port 110 being assigned a separate bit. Multicast frames are sent to the local ports 110 simply by setting multiple destination bits and writing the frame into the microprocessor-to-port buffer 362. For instance, local ports 0, 1 and 2 might be destinations for a multicast frame. The microprocessor 124 would set the destination bits to be “0111” and write the frame once into the port frame buffer 362. The microprocessor interface module 360 would then ensure that the frame would be sent to port 0 first, then to port 1, and finally to port 2. In the preferred embodiment, the frame is always sent to the lowest numbered port 110 first.

Once a frame is completely written to the port frame buffer 362 and the destination bits are set, a ready signal is sent by the microprocessor interface module 360 to the OPM(s) 450, 452 designated in the destination bits. When the OPM 450, 452 is ready to send the frame to its link control module 300, it asserts a read signal to the microprocessor interface module 360 and the MIM 360 places the frame data on a special data bus connecting the OPMs 450, 452 to the MIM 360. The ready signal is unasserted by the MIM 360 when an end of frame is detected. The OPM 450, 452 then delivers this frame to its link controller module 300, which then communicates the frame out of the port 110, 116. The microprocessor-to-port frame traffic has higher priority than the regular port traffic. This means that the only way a frame can get stuck in buffer 362 is if the Fibre Channel link used by the port 110 goes down. When the microprocessor 124 is sending frames to the ports 116, the OPM 452 buffers the frames received from its fabric interface module 160 that is destined for its port 110, 116.

Frames destined for the fabric interface are sent to the extra FIM 162 by placing the frame in the microprocessor-to-fabric frame buffer 364 and writing the frame length in the control register. To avoid overflowing the iMS 180 or one of its virtual output queues 290, the microprocessor 124 must check for the gross_xoff signal and the destination's status in the XOFF mask 408 before writing to the fabric frame buffer 364. This is necessary because data from the fabric frame buffer 364 does not go through the memory controller 310 and its XOFF logic before entering the FIM 162 and the iMS 180. Since data in the fabric frame buffer 364 is always sent to the same FIM 162, there are no destination bits for the microprocessor 124 to program. The FIM 162 then receives a ready signal from the microprocessor interface module 360 and responds with a read signal requesting the frame from the fabric frame buffer 364. The remainder of the process is similar to the submission of a frame to a port 110 through the port frame buffer 362 as described above.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

1. A method for sending communications to a microprocessor in a switch over a crossbar comprising:
a) assigning port data destined for a first physical port over a crossbar a first class of service level;
b) assigning processor data destined for the microprocessor a second class of service level; and
c) sending port data and processor data over the same crossbar using a traffic shaping algorithm that treats port data and processor data differently according to their class of service level.

2. The method of claim 1, wherein the port data is assigned a switch destination address for the first physical port, and further wherein the processor data is assigned a switch destination address for the processor physical port that is serviced by the processor.

3. The method of claim 2, further comprising:
d) receiving the port data and the processor data from the crossbar;
e) submitting the port data to a first module handling data to be sent over the first physical port; and
f) submitting the processor data to a processor port module handling data to be sent over the processor physical port.

4. The method of claim 3, further comprising recognizing the processor data at the processor port module as being directed to the microprocessor and redirecting the processor data to the microprocessor while not sending the processor data over the processor physical port.

5. The method of claim 4, wherein the first physical port and the processor physical port are the same physical port sharing the same switch destination address.

6. The method of claim 4, wherein the step of receiving the port data and the processor data from the crossbar further comprises:
i) storing the port data and the processor data in a outbound queue structure according to the assigned switch destination address.

7. The method of claim 6, wherein the step of receiving the port data and the processor data from the crossbar further comprises:
ii) subdividing the outbound queue structure according to an outbound class of service indicator, and
iii) assigning all processor data to a predefined outbound class of service indicator.

8. The method of claim 7, wherein the processor data is recognized at the processor port module by its outbound class of service indicator.

9. The method of claim 8, wherein the microprocessor services a plurality of processor physical ports, and further wherein all processor data destined for the microprocessor is assigned a switch destination address for only a single pre-selected processor physical port.

10. The method of claim 4, wherein the processor port module has a first buffer for port data to be sent over the processor physical port and a second buffer for processor data.

11. The method of claim 10, wherein after the processor port module recognizes the processor data, the processor data is stored in the second buffer, the processor port module sends an interrupt to the microprocessor, and the microprocessor initiates reception of the processor data from the second buffer.

12. A method for sending processor data from a microprocessor to a destination within a switch comprising:
a) sending physical port data from an ingress port in the switch to an egress port in the switch over a crossbar;
b) ensuring that the destination is not congested;
c) if the destination is not congested,
i) placing the processor data in a frame buffer,
ii) providing routing information for the processor data, and
iii) signaling a module to receive the processor data and to transmit the data over the same crossbar used to send the physical port data.

13. A method for sending processor data from a microprocessor servicing a plurality of ports in a switch to at least two of the serviced ports for transmission outside the switch comprising:
a) placing the processor data in a frame buffer;
b) providing destination information indicating the destination ports;
c) signaling a first destination module indicated in the destination information to receive the processor data from the frame buffer and to transmit the data over a first destination port; and
d) signaling a second destination module indicated in the destination information to receive the processor data from the frame buffer and to transmit the data over a second destination port.

14. A data switch comprising:
a) a crossbar;
b) a physical port having a switch destination address;
c) a microprocessor servicing the physical port; and
d) an ingress memory subsystem storing data in a plurality of virtual output queues before transmission over the crossbar, the virtual output queues organized by switch destination addresses and an ingress class of service indicator, the ingress class of service indicator dividing data between port data for transmission out the physical port and processor data for transmission to the microprocessor.

15. The data switch of claim 14 further comprising:
e) an ingress traffic shaping algorithm servicing the data in the virtual output queues according to the ingress class of service indicators.

16. The data switch of claim 15, wherein processor data is serviced more frequently than port data by the ingress traffic shaping algorithm.

17. The data switch of claim 15, further comprising:
f) an egress memory subsystem storing data in a plurality of class of service queues after transmission over the crossbar, the class of service queues organized by switch destination addresses and an egress class of service indicator, wherein processor data is assigned to a particular egress class of service indicator.

18. The data switch of claim 17, wherein the ingress class of service indicator is different than the egress class of service indicator.

19. The data switch of claim 17 further comprising:
g) an engress traffic shaping algorithm servicing the data in the virtual output queues according to the egress class of service indicators.

20. A data switch comprising:
a) a plurality of ports including an ingress port and an egress port;
b) a crossbar for making a switched connection between the ingress port and the egress port;
c) a microprocessor servicing the egress port;
d) means for submitting data to the egress port and the microprocessor over the same crossbar.

21. A method for maintaining packet order comprising:
a) storing packets received for a destination from a first source in a first buffer;
b) storing a first indicator in a storage mechanism whenever one of the packets is stored in the first buffer;
c) storing packets received for the destination from a second source in a second buffer;
d) storing a second indicator on the storage mechanism whenever one of the packets is stored in the second buffer;
e) removing packets from the first and second buffer using the indicators stored in the storage mechanism to determine whether a next packet is removed from the first or second buffer.

22. The method of claim 21, wherein the first source is a first connection to a crossbar within a data switch, and the second source is a second connection to the crossbar.

23. The method of claim 22, wherein the destination is an egress port in the data switch.

24. The method of claim 22, wherein the destination is a microprocessor in the data switch.

25. The method of claim 21, wherein the storage mechanism is an order queue.

26. The method of claim 21, wherein the packet is either a variable length data frame or a fixed-sized data cell.

27. The method of claim 21, wherein the packet is formatted using a communication protocol chosen from the set comprising: a Fibre Channel frame, an Ethernet frame, and an ATM cell.
